(19) United States
(12) Patent Application Publication
(10) Pub. No.: US 2021/0252679 A1
(43) Pub. Date: Aug. 19, 2021

(54) Adjustable and Ratchet Wrench Combination

(71) Applicant: Thomas Carnesi, Torrance, CA (US)

(72) Inventor: Thomas Carnesi, Torrance, CA (US)

(21) Appl. No.: 16/792,513

(22) Filed: Feb. 17, 2020

(51) Int. Cl. B25B 23/00; B25B 13/14; B25B 13/46; B25B 15/04

(52) U.S. Cl. CPC B25B 23/0028; B25B 13/14; B25G 1/085; B25B 15/04; B25B 23/0035; B25B 13/463

(57) ABSTRACT

A two jaw adjustable wrench having two opposing jaws that adjust inward and outward, one jaw having a left hand thread and the opposing jaw having a right hand thread for ease of adjustment. The user rotates the central knurled wheel in either a clockwise or counterclockwise rotation. The direction of rotation influences the opposing jaws to move inward or outward for various fastener size adjustments.

Opposite end of the ratchet wrench has a universally adaptable and slideable ratchet wrench for accepting universal ¼″ hexagon tool bits such as a #1 and #2 Phillips or slotted screwdriver bits of various sizes. Both tool ends are easily retractable and extendable by sliding either tool forward for use and or retractable when not in use.

The Adjustable and Ratchet Wrench's upper housing half provides two pocket-slots to store the Phillip's #1 and #2 screwdriver attachment and a #1 & #2 slotted screwdriver attachment.

### BACKGROUND OF THE INVENTION/PRIOR ART

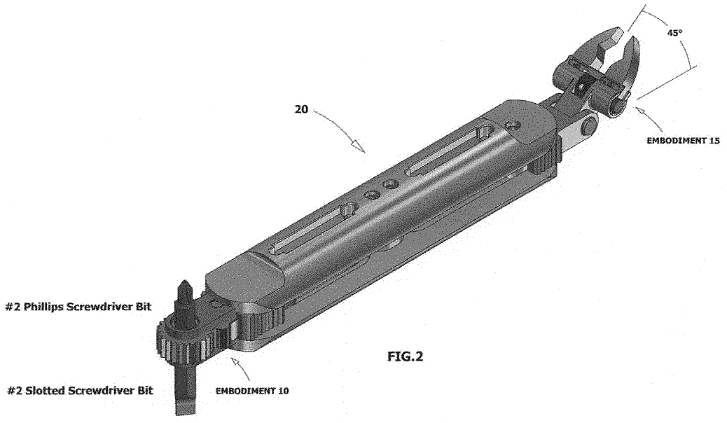

In patent application Ser. No. 16/010,821 filed on Jun. 28, 2018, in FIG. 2 & FIG. 3 describes a convertible and slideable ratchet wrench having an interchangeable component to accept ⅜″ and ¼″ driver attachment to accept universally adapted ¼ hexagonal configured Phillips #1 & #2 slotted screw driver bits and various hexagonal socket attachments for various needs.

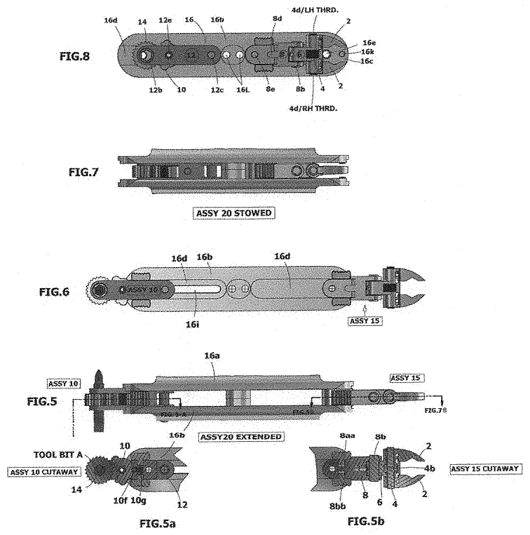

In patent application Ser. No. 16/559,586 October 2019, there is disclosed a two jaw adjustable and flexible wrench having a left hand and a right hand threaded jaws being adjusted by means of a right and left hand threaded screw shaft being manually rotated in either direction by means of a centrally located knurled rotation wheel to control the lateral inward and outward distal movement of the opposing jaws . . . Ref. FIG. 12 and FIG. 3, FIG. 9 and FIG. 10 . . . .

### SUMMARY

The current invention relates to an “Adjustable and Ratchet Wrench Combination”. The ratchet wench accepts various universal Phillips #1 & #2 and slotted screwdriver attachments and various hexagonal socket sizes. The adjustable end has two opposing jaw members that are adjustable by means of a right hand and left hand internal threaded screw. The opposing jaws are also flexible to 45 degrees upward and −45 degrees downward for various job assignments.

Crescent type wrenches and similar tools have been widely available in prior arts. For example, Crescent Tool Company, Channel Lock and Leatherman's have several portable combination tools sets.

The invention is intended to provide the user with an efficient, lightweight and portable pocket tool. It is designed for emergencies, easy storage and to fit into a pocket.
The adjustable ratchet component has two opposing jaws within a flexible yoke attachment that are movable inward or outward using an internal right- and left-hand threaded screw. This right- and left-hand thread screw is mated within the two opposing jaws' lower embodiment. The jaws are retained within said flexible yoke.
The ratchet wrench component accepts universal ¼″ diameter hex shaped male adapters such as #1 and #2 Phillips screwdriver bits and/or a slotted screwdriver bit for slotted type screws. The ratcheting's main gear has a centrally and hexagonally configured hole to accept a universal ¼″ diameter hexagonal mating body or stem. The interior diameter of the ¼″ hexagonal hole can also accept a universal ¼″ male adapter that accepts a universal ¼″ square driver for standard individual sockets of various sizes, both metric and inch size fasteners.

Both components extend for use and retract for storage into the enclosed upper and lower cylindrical handle halves.

### DESCRIPTION OF FIGURES

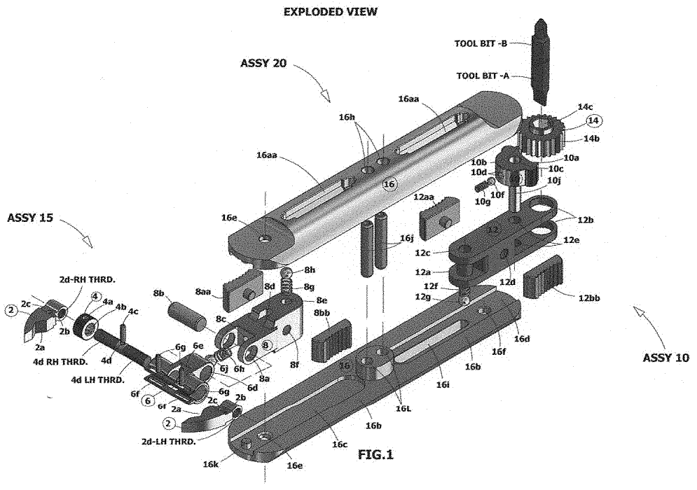

### FIG. 1 Exploded View of Embodiment 20

### Embodiment 15: A Two Jaw Flexible & Adjustable Wrench End

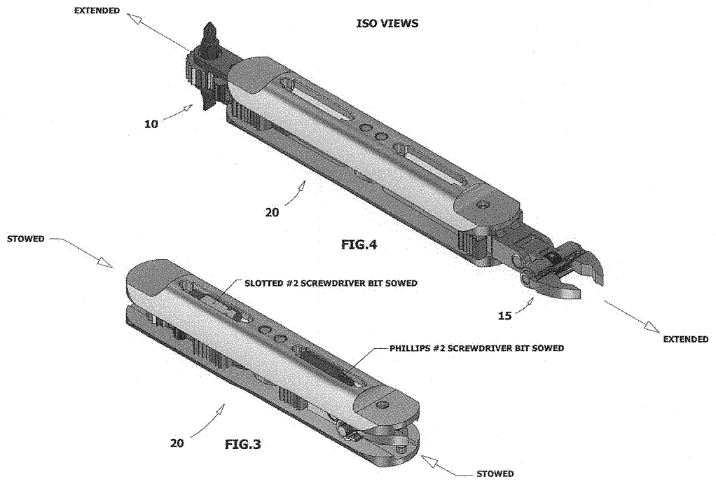

FIG. 1 is a perspective exploded view of the embodiment 20 showing the Jaw members 2 which have a V-Notch feature 2a located on both opposing Jaws interior, the Jaws interior right hand and left hand thread FIG. 2d/R and 2d/L which are both influenced by a right and left hand threaded interior screw FIG. 4d left hand and 4d right hand which rotate within the interior slotted channel in FIG. 6b horizontal channel of the T-frame FIG. 6, FIG. 2b which are the vertical holes that retain the two horizontal stop pins FIG. 6e that controls the opposing Jaws 2d/R and 2d/L to either expand and or retracted within right and left hand slots FIG. 6<i's limit. The central knurled jaws adjusting wheel, FIG. 4, is rotatable to either direction to adjust the Jaws 2 to ride either inward or outward adjustment when the wheel FIG. 4 is rotated in either direction, said Jaws FIG. 2c vertical holes ride horizontally within slot FIG. 6d and are retained with FIG. 6e stop pins of the upper horizontal T-Frame in FIG. 6, and FIG. 2e which housed the exterior Jaws 2 and the exterior FIG. 2c diameters travel inward or outward within FIG. 6c horizontal bore of the T-Frame FIG. 6, Jaw FIG. 2d/RH is the right and left hand of FIG. 2d/LH internal thread of Jaws 2; FIG. 2e is the outer cylindrical diameters are influenced by the threaded internal screw in FIG. 4, clockwise and or counterclockwise rotation influences the 2d/left hand and right hand jaws FIG. 2 to move simultaneously inward or outward influenced by internal thread Adjusting Screw FIG. 4, controlled by the central knurled wheel 4, the right hand 4b external thread mates with Jaw 2dR, thread 4c mates with 2e opposing Jaw FIG. 2d/L—the right and left hand Threaded shaft FIG. 4 being rotated by the central Knurled Wheel FIG. 4b, 4c is the interior bore FIG. 4b mates with the horizontal right hand and left hand thread shaft FIG. 4. The central knurled wheel FIG. 8 being retained within the through slot FIG. 6f of T-Frame FIG. 6. Upward rotation of the Central Knurled Wheel FIG. 4 influences said opposing Jaws 2d/LH and 2d/RH to move to an inward adjustment, downward rotation causes said opposing Jaws 2d/left hand and 2d/right hand to expand to an outward adjustment to a larger FIG. 2 Jaws distal opening, FIG. 6k compression spring and detente ball bearing FIG. 6j retains the extended wrench embodiment FIG. 15 being retained by FIG. 14k stop pin to a maximum outward extension of embodiment 15 when in use or when being retracted back within of the upper and lower housing internal track FIG. 14a and FIG. 14b housing and 14c. FIG. 14l compression spring find détente ball bearing FIG. 14m; FIG. 6aa and 6bb are the serrated gripping aids to facilitate the forward and return slide function of wrench embodiment FIG. 15., FIG. 16aa and FIG. 16bb are the stowage pockets for the Phillips #2 driver attachment and slotted #2 slotted screwdriver attachment.

### Embodiment 10: Ratcheting Wrench Assembly

The opposite end unit being retained within a an upper and lower ratcheting frame 12, the forward ratcheting gear in FIG. 14 is rotate-able in either direction and pivots within upper and lower ratcheting frame FIG. 12 having a vertical upper and lower bores in FIG. 2c, the ratcheting gear 14 is locked in one rotational direction and being influenced by the ratcheting Pawl in FIG. 10 that is meshed with the ratcheting gear 14 exterior teeth 14b; the ratcheting pawl in FIG. 10 frees the ratcheting wheel in the clockwise rotational direction for tightening and locking in the counterclockwise rotation with the serrated exterior ratcheting gear FIG. 14 of said ratcheting gear FIG. 10, each ratcheting sequence either locks said ratcheting gear FIG. 10 in either a clockwise and or counterclockwise rotation being controlled by FIG. 10g compression and FIG. 10f détente ball bearing nestled within two notches on the ratcheting pawl 10 to accept the spring induced détente spherical ball FIG. 10f to either lock said FIG. 10 ratcheting pawl to either tighten and or loosen fasteners of a certain configuration; ratcheting embodiment FIG. 10 is slidcable to an extended position for use and returned inward to when not in use, said ratcheting embodiment 10 rides with FIG. 4c upper and lower track of FIG. 14a 14b, ratcheting gear FIG. 10 has a hexagonal configured hole 8c to accept universally adaptable ¼″ diameter hex shaped fastener bits such as Phillip's #1 and #2 screwdrivers and slotted screwdriver of various sizes to accommodate various screw sizes. FIGS. 12aa and 12bb are the knurled slides outer serrated grips for ease of operation to facilitate the sliding path of the ratcheting embodiment 10, FIG. 12g is the main vertical guide pin to control the inward and extended path of embodiment 10, retainer pin 10j is for the pivotal axis of pawl FIG. 10 swivel direction, compression spring FIG. 10h and détente ball bearing FIG. 10f retains ratcheting embodiment 10 in the retracted position in FIG. 14f and FIG. 14g vertical holes within FIG. 14b lower half housing FIG. 14

### DESCRIPTION OF DRAWING FIGURES

FIG. 1 is an exploded view of the Portable Dual End Wrench Assembly 20 with all relevant components 10 and 15 Sub-Assembly embodiments.

FIG. 2 is an ISO view of the assembled Portable Wrench Assembly 20 with embodiment 10 extended. 15 also extended, and the Jaws sub-Assy. swiveled 45 degrees upward.

FIG. 3 is an ISO view of the assembled Portable Wrench Assembly 20 with embodiment 10 and 15 extended.

FIG. 4 is an isometric view of the Wrench Assembly's—Ratcheting assembly 10, and the Two Jaw Adjustable Wrench in the stowed positions.

FIG. 5 is a right side profile view of the dual end wrench assembly with the Ratcheting Assembly embodiment 10 fully extended and the Adjustable Two Jaw Wrench, also fully extended.

FIG. 5a is a section view showing the internal Ratcheting Gear 14 and Ratcheting pawl 10 extended.

FIG. 5b is a section view showing the internal adjustable wrench's right hand and left hand threaded jaws and their mating right hand and left hand threaded male screw.

FIG. 6 is lower half embodiment 20 showing the Two Jaw wrench assembly extended and the opposite end showing the ratcheting embodiment extended within the lower half of the wrench housing FIG. 16.

FIG. 7 is a right hand side view of the embodiment 20 showing embodiment 10 and 15 in the stowed positions.

FIG. 8 is a bottom view of the lower housing 16 showing embodiment 10 and 15 within the guide channel 16d in the retracted positions.

FIG. 9 is a section view of lower half section view of the embodiment 10 ratcheting driver assembly showing the ratcheting gear 14 and the ratcheting Pawl 10 engaged within lower ratchet housing 12.

FIG. 10 is a top view of the ratcheting housing embodiment 10.

FIG. 10a is a cross section view of embodiment 10 showing the ratcheting components.

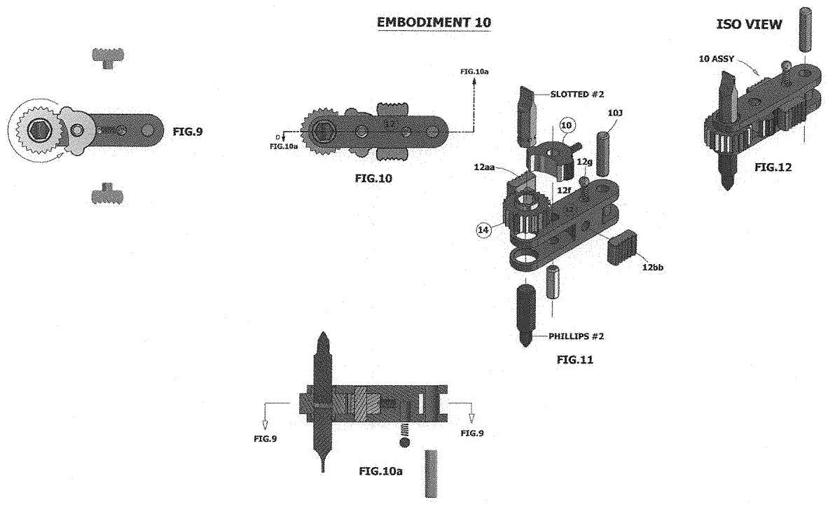

FIG. 11 is an exploded view of the embodiment 10 ratcheting mechanism and its relevant components.

FIG. 12 is an ISO view of the ratcheting embodiment 10 showing a complete ratcheting assembly.

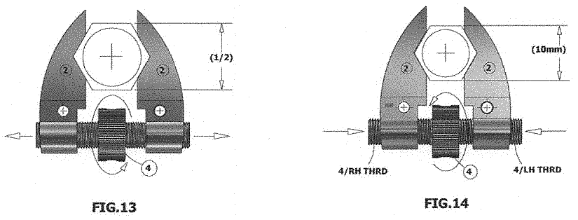

FIG. 13 is a top profile view of the wrench sub-assembly-right hand and left hand jaw members 2 are adjusted outward to a ½ inch hexagonal bolt size.

FIG. 14 is a top profile view of the wrench sub-assembly-right hand and left hand jaw members 2 are adjusted inward to a 10 mm size hexagonal boll size.

### DESCRIPTION OF THE INVENTION

“Adjustable and Ratchet Wrench Combination”, Embodiment 20: consisting of a two jaw adjustable wrench end and an opposite end which is a ratcheting component. Both are extendable and retractable.

The adjustable range of the two jaw members is approximately ¼″ to ⅝″ and 6 mm to 17 mm maximum opening. The adjustable wrench end can be used on both hexagonal and square configured fasteners of various sizes. There are two ways the tool can grip the fasteners:

#1: Smaller square or hex shaped size fasteners can be gripped from either the v-end diamond notch at 120 degrees configured within the jaws or the interior central opening.

#2: When the user rotates the central knurled cylindrical knob in an upward and clockwise rotation, the opposing jaws move apart to a wider and larger opening for larger hexagonal or square fasteners. Counterclockwise or downward rotation of the knurled cylindrical knob reactivates the jaws to move back inwardly or closer together for smaller hex or square size fasteners.

The internal right-hand and left-hand knurled thread screw is housed within the jaws' upper frame cylindrical square slotted feature. The thread screw is secured by the central external knurled cylindrical thumb wheel.

The two opposing jaws' maximum adjustments (distance outward) are each secured by a dowel pin to stop any further outward movement. This prevents the jaws from dissembling from the yoke housing. When adjusted outward, the square feature of the yoke housing rides within the internal track of the upper and lower exterior handle and is secured by a stop pin. To extend for use or retract for storage, the user grips the wrench assembly's knurled outer guide pads inward with his thumb and index fingers and slides the desired component in or out at either end.

1. An adjustable, extendable, retractable two jaw wrench having jaws moving simultaneously together or apart depending upon the axial rotation of the central knurled thumb spacer to adjust the opposing jaws to the desired hexagonal or square shaped fastener to be tightened or loosened. The opposing jaws each having a left and right hand thread to accomplish their simultaneous movement inward or apart.
The wrench of claim 1, wherein said first and second jaws being moved by rotating a member having first and second threaded members connected thereto. One end of said first threaded members male with internal threads formed in said first jaw member and said second threaded member mates with internal threads in second jaw member.
The wrench of claim 2, wherein said first and second jaw members are housed in a slideable yoke member within the confines of a upper and lower track within the upper and lower main housing covers.
An extendable and retractable ratcheting wrench in claim 3, being extendable and retractable within the confines of a slotted track on the opposite end of the tools upper and lower main housing cover.
The ratchet wrench mechanism in claim 4, having a serrated main ratcheting gear and a ratcheting two way swiveled pawl to lock said ratcheting gear m one direction for tightening of various fasteners and or swung in the opposite direction to lock said ratcheting gear for loosening of various fasteners. Said ratcheting gear provides a universal hexagonal configured hole to accept universal hex shaped Phillip's and slotted drivers for fasteners of various sizes and a universal adapter having a ¼″ square top to accept ¼″ square universal sockets.
